(19) United States
(12) Patent Application Publication
(10) Pub. No.: US 2023/0081629 A1
(43) Pub. Date: Mar. 16, 2023

(54) RACK AND PINION ASSEMBLY FOR A STEERING ASSEMBLY

(71) Applicant: BOMBARDIER RECREATIONAL PRODUCTS INC., Valcourt (CA)

(72) Inventors: Martin HEON, Sherbrooke (CA); Philippe ROY RICHARD, Montreal (CA)

(21) Appl. No.: 17/801,085

(22) PCT Filed: Feb. 18, 2021
(86) PCT No.: PCT/IB2021/051383

§ 371 Date: Aug. 19, 2022

Related U.S. Application Data
(60) Provisional application No. 62/983,157, filed on Feb. 28, 2020.

(51) Int. Cl. B62D 5/04; B62D 1/20; B62D 7/16

(52) U.S. Cl. CPC B62D 5/0409; B62D 1/20; B62D 7/163

(57) ABSTRACT

A rack and pinion assembly for a steering assembly is disclosed. The rack and pinion assembly has: a housing; a rack disposed in the housing, the rack being translatable in the housing; a pinion engaging the rack for causing translation of the rack; and at least one rolling element connected to the rack. The at least one rolling element is translatable with the rack. The at least one rolling element rolls along an inner surface of the housing as the rack translates. A steering assembly having the rack and pinion assembly and a vehicle having the steering assembly are also disclosed.

### CROSS-REFERENCE

The present application claims priority to U.S. Provisional Patent Application No. 62/983,157, filed Feb. 28, 2020, the entirety of which is incorporated herein by reference.

### FIELD OF TECHNOLOGY

The present technology relates to rack and pinion assemblies for steering assemblies.

### BACKGROUND

A rack and pinion assembly typically consists of a pinion that engages a rack that is disposed in a housing. Rotation of the pinion causes translation of the rack. In a wheeled vehicle, such as a side-by-side off-road vehicle, the pinion is usually operatively connected to a steering wheel via a steering column, and the rack is usually operatively connected to the front wheel via tie rods. When the driver turns the steering wheel, the pinion turns which causes the rack to translate in the housing. The translation of the rack causes displacement of the tie rods which steer the wheels in the direction corresponding to the direction of rotation of the steering wheel.

In order to function properly, the rack has to translated with as little constraint as possible. This is usually achieved by providing bearings connected at a set position inside the housing that support the rack. When the pinion rotates, the rack translates inside the housing relative to the bearings. The bearings reduce friction, thus facilitating the translation of the rack.

However, obtaining tight tolerances in a rack and pinion assembly such as the one described above can be difficult. Also, under heavy steering loads, the loads applied to the rack can under certain circumstance increase friction which results in increased steering force being required by the driver to steer the vehicle.

Therefore, there is a desire for a rack and pinion assembly that addresses at least some of the above deficiencies.

### SUMMARY

The present technology provides a rack and pinion assembly in which at least one rolling element is connected to the rack and translates with the rack. This allows tight tolerance to be provided and increase friction is less likely to occur when heavy loads are applied to the rack. In some embodiments, the housing defines at least one groove and the at least one rolling element rolls inside the at least one groove.

According to one aspect of the present technology, there is provided a rack and pinion assembly for a steering assembly. The rack and pinion assembly has: a housing; a rack disposed in the housing, the rack being translatable in the housing; a pinion engaging the rack for causing translation of the rack; and at least one rolling element connected to the rack. The at least one rolling element is translatable with the rack. The at least one rolling element rolls along an inner surface of the housing as the rack translates.

In some embodiments, the housing defines at least one laterally extending groove; and the at least one rolling element rolls inside the at least one laterally extending groove.

In some embodiments, the at least one rolling element is at least one first rolling element. The rack and pinion assembly also has at least one second rolling element connected to the rack. The at least one second rolling element is laterally spaced from the at least one first rolling element. The at least one second rolling element is translatable with the rack. The at least one second rolling element rolls inside the at least one groove.

In some embodiments, the at least one laterally extending groove is three angularly spaced laterally extending grooves. The at least one rolling element is three angularly spaced rolling elements. Each of the three rolling elements is received in a corresponding one of the three laterally extending grooves.

In some embodiments, the housing defines an aperture; the three laterally extending grooves include first, second and third grooves; the aperture is circumferentially between the first and second grooves; the third groove is opposite the aperture; a first angle between the first and second grooves is greater than a second angle between the second and third grooves; and the first angle is greater than a third angle between the first and third grooves. The rack and pinion assembly also has: a tie rod connector fastened to the rack; and at least one fastener fastening the tie rod connector to the rack, the fastener passing through the aperture. The tie rod connector is configured to connect to tie rods.

In some embodiments, the first angle is 150 degrees; and the second and third angles are 105 degrees each.

In some embodiments, a spider is connected to the rack. The spider has three legs. Each of the three rolling elements is rotationally connected to a corresponding one of the three legs.

In some embodiments, the at least one rolling element is three angularly spaced rolling elements.

In some embodiments, the housing defines an aperture; the three rolling elements include first, second and third rolling elements; the aperture is circumferentially between the first and second rolling elements; the third rolling element is opposite the aperture; a first angle between the first and second rolling elements is greater than a second angle between the second and third rolling elements; and the first angle is greater than a third angle between the first and third rolling elements. The rack and pinion assembly also has a tie rod connector fastened to the rack; and at least one fastener fastening the tie rod connector to the rack, the fastener passing through the aperture. The tie rod connector is configured to connect to tie rods.

In some embodiments, the first angle is 150 degrees; and the second and third angles are 105 degrees each.

In some embodiments, a spider is connected to the rack. The spider has three legs. Each of the three rolling elements is rotationally connected to a corresponding one of the three legs.

In some embodiments, the three rolling elements are three first rolling elements. Three second rolling elements are connected to the rack. The three second rolling element are laterally spaced from three first rolling elements. The three second rolling element are translatable with the rack. The three second rolling elements rolling along the inner surface of the housing as the rack translates.

In some embodiments, the three second rolling elements are rotationally connected to a spider. The spider is connected to the rack. The spider has three legs. Each of the three second rolling elements is rotationally connected to a corresponding one of the three legs.

In some embodiments, the at least one rolling element is at least one first rolling element. At least one second rolling element is connected to the rack. The at least one second rolling element is laterally spaced from the at least one first rolling element. The at least one second rolling element is translatable with the rack. The at least one second rolling element rolls along the inner surface of the housing as the rack translates.

In some embodiments, the housing defines an aperture. The rack and pinion assembly also has: a tie rod connector fastened to the rack laterally between the at least one first rolling element and the at least one second rolling element; and at least one fastener fastening the tie rod connector to the rack, the fastener passing through the aperture. The tie rod connector is configured to connect to tie rods.

In some embodiments, the at least one rolling element is at least one roller.

In some embodiments, the rack includes: a first rack portion having teeth for engaging the pinion; and a second rack portion connected to the first rack portion by an articulated joint. The at least one rolling element is connected to the second rack portion.

In some embodiments, the articulated joint is a ball joint.

In some embodiments, a slider abuts the first rack portion. The first rack portion is disposed between the pinion and the slider. A spring biases the slider against the first rack portion.

In some embodiments, the rack includes: a first rack portion having teeth for engaging the pinion; and a second rack portion connected to the first rack portion by an articulated joint. The at least one rolling element is at least one first rolling element connected to the second rack portion. The rack and pinion assembly also has at least one second rolling element connected to the second rack portion. The at least one second rolling element is laterally spaced from the at least one first rolling element. The at least one second rolling element is translatable with the rack. The at least one second rolling element rolls along the inner surface of the housing as the rack translates. The housing defines an aperture. The rack and pinion assembly also has: a tie rod connector fastened to the second rack portion, the tie rod connector being disposed laterally between the at least one first rolling element and the at least one second rolling element; and at least one fastener fastening the tie rod connector to the second rack portion, the fastener passing through the aperture. The tie rod connector is configured to connect to tie rods.

In some embodiments, a first spider is connected to the second rack portion. The first spider has three legs. A second spider is connected to the second rack portion. The second spider has three legs. The tie rod connector is disposed laterally between the first and second spiders. The at least one first rolling element is three first rolling elements. Each of the three first rolling element is rotationally connected to a corresponding one of the three legs of the first spider. The at least one second rolling element is three second rolling elements. Each of the three second rolling element is rotationally connected to a corresponding one of the three legs of the second spider.

In some embodiments, the housing defines three angularly spaced laterally extending grooves. Each of the three first rolling elements is received in a corresponding one of the three laterally extending grooves. Each of the three second rolling elements is received in a corresponding one of the three laterally extending grooves.

In some embodiments, the at least one first rolling element is at least one first roller; and the at least one second rolling element is at least one second roller.

According to another aspect of the present technology, there is provided a steering assembly having: a steering wheel; a steering column operatively connected to the steering wheel; the above rack and pinion assembly, the pinion being operatively connected to the steering column; a left tie rod operatively connected to the rack; and a right tie rod operatively connected to the rack.

In some embodiments, a power steering unit is operatively connected to the steering column.

According to another aspect of the present technology, there is provided a vehicle having: a frame; at least one seat connected to the frame; a front left wheel operatively connected to the frame; a front right wheel operatively connected to the frame; at least one rear wheel; and the above steering assembly. The left tie rod is operatively connected to the front left wheel, and the right tie rod is operatively connected to the front right wheel.

For purposes of this application, terms related to spatial orientation such as forwardly, rearward, upwardly, downwardly, left, and right, are as they would normally be understood by a driver of the vehicle sitting thereon in a normal riding position. Should any discrepancy exist between definitions provided in the present document and corresponding definitions in a document incorporated herein by reference, the definitions provided in the present document take precedence.

Embodiments of the present technology each have at least one of the above-mentioned object and/or aspects, but do not necessarily have all of them. It should be understood that some aspects of the present technology that have resulted from attempting to address the above-mentioned deficiencies of the prior art may not satisfy this object and/or may satisfy other objects not specifically recited herein.

Additional and/or alternative features, aspects and advantages of embodiments of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a perspective view of a side-by-side off-road vehicle taken from a front, left side;

FIG. 2 is a perspective view of a steering assembly of the vehicle of FIG. 1 taken from a front, left side.

FIG. 3 is an exploded view of a rack and pinion assembly of the steering assembly of FIG. 2;

FIG. 4 is partial cross-section of the rack and pinion assembly of FIG. 3;

FIG. 5 is a cross-section of the rack and pinion assembly of FIG. 3;

FIG. 6 is another cross-section of the rack and pinion assembly of FIG. 3;

FIG. 7 is a partial cross-section of part of a housing, a rack and spider assemblies of the rack and pinion assembly of FIG. 3;

FIG. 8 is a perspective view of the part of the housing of FIG. 7 taken from a front, left side;

FIG. 9 is a left side elevation view the part of the housing of FIG. 7;

FIG. 10 is a cross-section of the part of the housing of FIG. 7;

FIG. 11 is a perspective view the spider assemblies and a corresponding part of the rack of FIG. 7; and

FIG. 12 is a left side elevation view of one of the spider assemblies of FIG. 7.

### DETAILED DESCRIPTION

The present technology will be described with respect to a four-wheel, off-road vehicle 10 having two side-by-side seats and a steering wheel, also known as a side-by-side vehicle (SSV). However, it is contemplated that some aspects of the present technology may apply to other types of vehicles such as, but not limited to, off-road vehicles having a handlebar and a straddle seat (i.e. an all-terrain vehicle (ATV)), off-road vehicles having more or less than four wheels and/or more or less than two seats, and on-road vehicles.

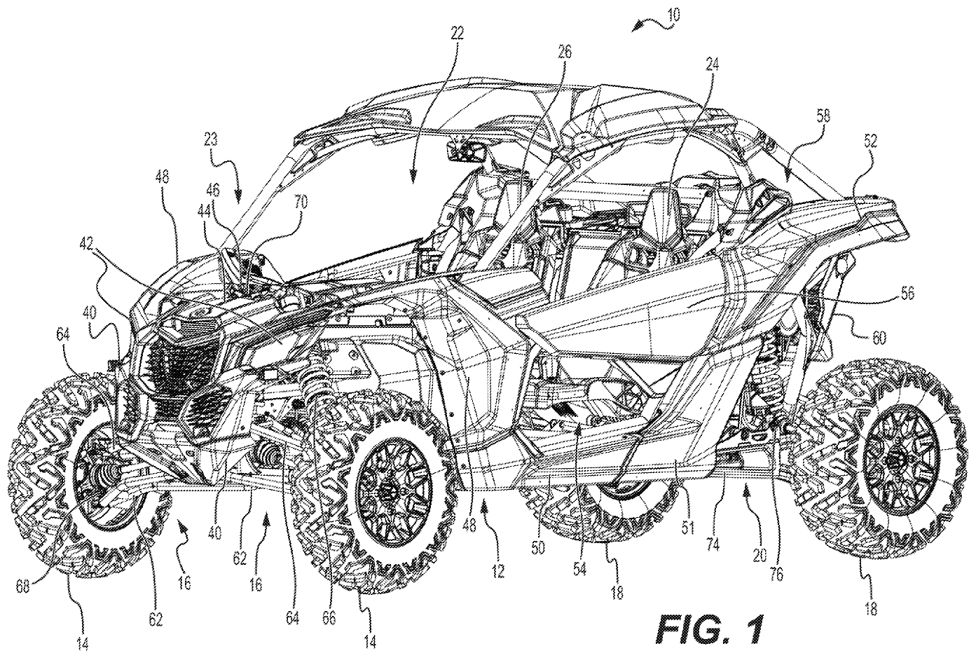

The general features of the off-road vehicle 10 will be described with respect to FIG. 1. The vehicle 10 has a frame 12, two front wheels 14 connected to a front of the frame 12 by front suspension assemblies 16 and two rear wheels 18 connected to the frame 12 by rear suspension assemblies 20.

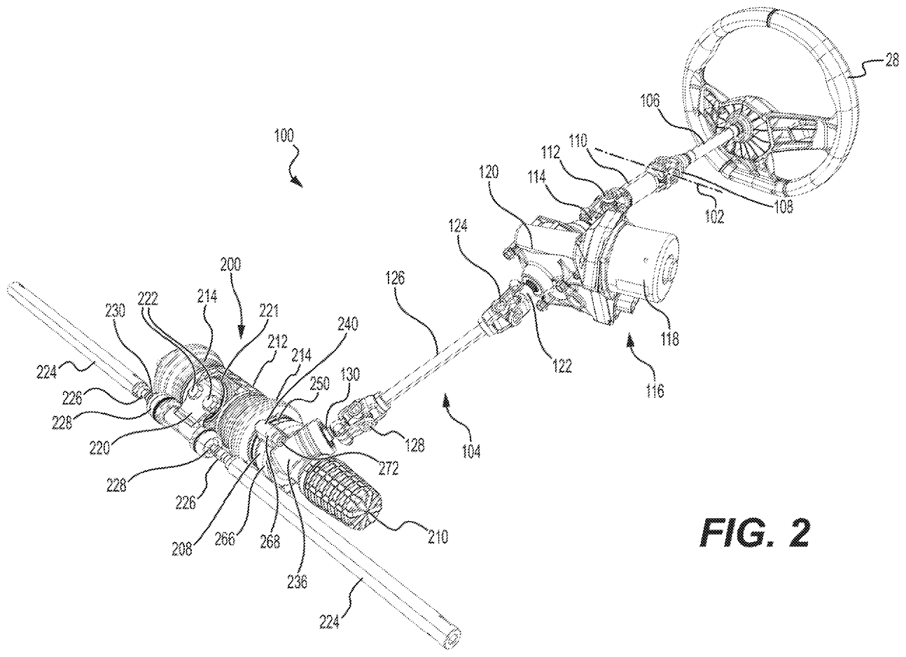

The frame 12 defines a central cockpit area 22 inside which are disposed a driver seat 24 and a passenger seat 26. The frame 12 also defines a roll cage 23 disposed over the cockpit area 22. In the present embodiment, the driver seat 24 is disposed on the left side of the vehicle 10 and the passenger seat 26 is disposed on the right side of the vehicle 10. However, it is contemplated that the driver seat 24 could be disposed on the right side of the vehicle 10 and that the passenger seat 26 could be disposed on the left side of the vehicle 10. A steering wheel 28 (FIG. 2) is disposed in front of the driver seat 24. The steering wheel 28 is used to turn the front wheels 14 to steer the vehicle 10 as will be described in greater detail below. Various displays and gauges (not shown) are provided in front of the driver seat 24 to provide information to the driver regarding the operating conditions of the vehicle 10. Examples of displays and gauges include, but are not limited to, a speedometer, a tachometer, a fuel gauge, a transmission position display, and an oil temperature gauge.

An engine (not shown) is connected to the frame 12 behind the seats 24, 26. The engine is connected to a continuously variable transmission (CVT, not shown) disposed on a left side of the engine. The CVT is operatively connected to a geared transmission (not shown) to transmit torque from the engine to the transmission. The transmission is disposed behind the engine. The transmission is operatively connected to the front and rear wheels 14, 18 to propel the vehicle 10. A fuel tank (not shown) is disposed in front of the engine. The fuel tank is disposed in part behind the seats 24, 26 and in part between the seats 24, 26.

The vehicle 10 has body panels connected to the frame 12. The panels help protect the internal components of the vehicle 10 and provide some of the aesthetic features of the vehicle 10. Front panels 40 are connected to a front of the frame 12. The front panels 40 are disposed forward of the front suspension assemblies 16 and laterally between the front wheels 14. The front panels 40 define two apertures inside which the headlights 42 of the vehicle 10 are disposed. A cover 44 extends generally horizontally reward from a top of the front panels 40. The cover 44 defines an aperture 46 through which tops of the front suspension assemblies 16. Front fenders 48 are disposed rearward of the front panels 40 on each side of the vehicle 10. Each front fender 48 is disposed in part above and in part behind of its corresponding front wheel 14. Lower panels 50 extend along the bottom of the frame 12. Each lower panel 50 has a front end disposed under the bottom portion of its corresponding front fender 48 and extends rearward therefrom. Generally L-shaped panels 51 are disposed behind the lower panels 50. Generally L-shaped rear fenders 52 extend upward and then rearward from the upper ends of the panels 51. Each rear fender 52 is disposed in part above and in part forward of its corresponding rear wheel 18.

On each side of the vehicle 10, the front fender 48, the lower panel 50, the panel 51 and the rear fender 52 define a passage 54 through which a driver (or passenger depending on the side of the vehicle 10) can enter or exit the vehicle 10. Each side of the vehicle 10 is provided with a door 56 that selectively closes an upper portion of the corresponding passage 54. When the doors 56 are closed, the lower portions of the passages 54 are still opened. It is contemplated that nets could extend in the lower portions of the passages 54 when the doors 56 are closed or that the doors 56 could be larger so as to close the lower portions of the passages 54.

As best seen in FIG. 1, the rear fenders 52 define a cargo space 58 therebetween behind the seats 24, 26. The cargo space 58 has a floor (not shown) extending horizontally between the rear fenders 52. It is contemplated that the floor could be replaced by a cargo box that can be tilted in order to dump its content.

Rear panels 60 extend generally horizontally downward from the rear end of the floor. The rear panels are disposed laterally between the rear wheels 18. The rear panels define apertures to receive the brake lights (not shown) of the vehicle 10. It is contemplated that the brake lights could be replaced with reflectors or that reflectors could be provided in addition to the brake lights. Engine compartment walls (not shown) extend forward of each lateral end of the rear panels below the floor. Each engine compartment wall is disposed laterally between one side of the engine and a corresponding rear wheel 18. The engine compartment walls, the rear panels 60 and the floor together define a portion of an engine compartment containing the engine, the CVT and the transmission.

The front suspension assemblies 16 will now be described in more detail. As the left and right front suspension assemblies 16 are mirror images of each other, only the left front suspension assembly 16 will described in detail. Components of the right front suspension assembly 16 that correspond to those of the left front suspension assembly 16 have been labeled with the same reference numerals in the figures.

The front suspension assembly 16 is a double A-arm suspension assembly. As such, the front suspension assembly 16 has a lower A-arm 62, an upper A-arm 64 and a shock absorber 66. The shock absorber 66 includes a coil spring disposed around a hydraulic shock, and the hydraulic shock has a separate reservoir connected to it. Since shock absorbers of this type are well known, the shock absorber 66 will not be described in greater detail.

The laterally inward ends of the lower A-arm 62 are pivotally connected to the frame 12. The laterally inward ends of the upper A-arm 64 are similarly pivotally connected to the frame 12. The laterally outward ends of the A-arms 62 and 64 are pivotally connected to the bottom and the top of a knuckle 68 (only shown for the right front suspension assembly 16) respectively. The knuckle 68 pivots relative to the A-arms 62, 64 about a steering axis.

A shaft (not shown) is connected to the top of the of the upper A-arm 64 near its laterally outward end. The shaft pivotally connects the lower end of the shock absorber 66 to the upper A-arm 64. It is contemplated that the lower end of the shock absorber 66 could be connected to the lower A-arm 66. From its lower end, the shock absorber 66 extends upward, rearward and laterally inward. The upper end of the shock absorber 66 is pivotally connected to the frame 12. A bent member 70 is disposed in front of the upper ends of the shock absorbers 66 of the left and right suspension assemblies 16 such that the upper ends of the shock absorbers 66 are held between the bent member 70 and the frame 12. As can be seen, the upper ends of the shock absorbers 66 extend through the aperture 46 in the cover 44 of the vehicle 10. As a result, the upper ends of the shock absorbers 66 and the bent member 70 are disposed above the cover 44 and are visible from outside the vehicle 10.

A sway bar (not shown) is operatively connected between the upper A-arms 64 of the left and right front suspension assemblies 16.

The rear left suspension assemblies 20 will be described. Only the left rear suspension assembly 20 is shown in FIG. 1. The rear right suspension assembly 20 is a mirror image of the rear left suspension assembly 20 and as such will not be described herein. The rear suspension assembly 20 has a trailing arm 72, a shock absorber 74, and upper, toe and lower links (not shown). The trailing arm 72 and the links are connected to a knuckle (not shown). The rear wheel 18 is rotationally connected to the knuckle.

International Patent Publication Number WO 2018/033767 A1, published Feb. 22, 2018, the entirety of which is incorporated herein by reference, provides additional description of a vehicle similar to the vehicle 10.

Turning now to FIG. 2, a steering assembly 100 of the vehicle 10 will be described. The steering assembly has the steering wheel 28. The steering wheel 28 is connected via a steering wheel position adjustment mechanism (not shown) to a steering wheel support frame structure (not shown) which is connected to the frame 12 of the vehicle 10. The steering wheel position adjustment mechanism allows the steering wheel 28 to be pivoted about a laterally extending horizontal axis 102 such that the height of the steering wheel 28 can be adjusted.

The steering wheel 28 is connected by a steering column 104 to a rack and pinion assembly 160. The steering column 104 is made of an assembly of shafts 106, 110, 114, 122, 126 and universal joints 108, 112, 124, 128. It is contemplated that the steering column 104 could be made of more or less shafts and joints than in the present embodiment. The steering wheel 28 is connected to the longitudinally extending steering shaft 106. The steering shaft 106 pivots about the axis 102 with the steering wheel 28. The steering shaft 106 is connected by the universal joint 108 to the steering shaft 110. The steering shaft 110 extends downward and forward from the universal joint 108. The steering shaft 110 is connected by the universal joint 112 to the steering shaft 114. The steering shaft 114 is the input shaft of a power steering unit 116. In the present embodiment, the power steering unit 116 includes an electric motor 118 and a gear box assembly 120. The power steering unit 116 applies torque to assist in steering the vehicle 10. The amount of torque applied by the power steering unit 116 varies depending on the operating conditions of the vehicle 10. As such, the steering assembly 100 of the vehicle 10 has what is commonly referred to as a power steering system. The steering shaft 122, which is the output shaft of the power steering unit 116, is connected by the universal joint 124 to the steering shaft 126. The steering shaft 126 extends downward, forward and rightward from the universal joint 124. The steering shaft 126 is connected by the universal joint 128 to an input shaft 130 of the rack and pinion assembly 200.

With reference to FIGS. 2 to 4, the rack and pinion assembly 200 has a rack 202 having teeth 204 engaged by a toothed pinion 206. The rack 202 and the pinion 206 are disposed inside a housing 208. The pinion 206 is connected to the input shaft 130 and is disposed on a left side of rack and pinion assembly 200. A cap 210 is mounted to the left end of the housing 208. The cap 210 is sufficiently long to accommodate the full translation of the rack 202 toward the left. It is contemplated that instead of having a cap 210, the housing 208 could be made longer. A cover 212 is disposed around the housing 208 laterally between the ends the housing 208. The cover 212 has flexible bellows 214 extending from its left and right ends and disposed around the housing 208.

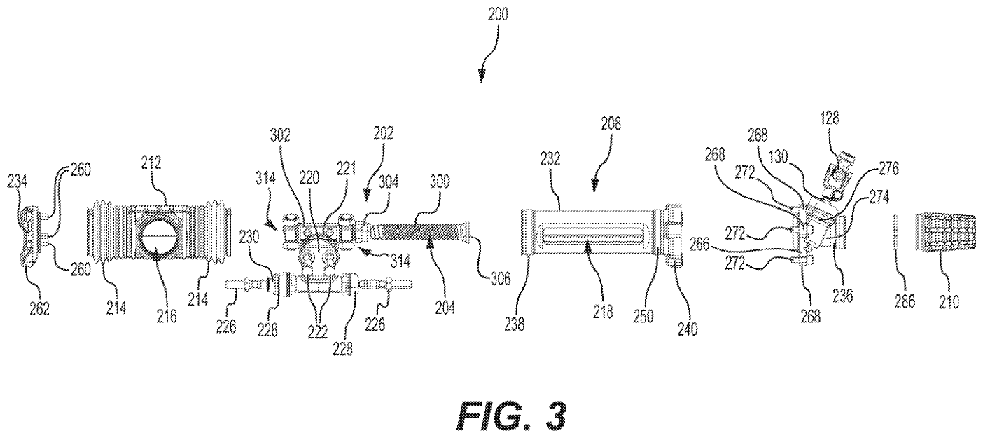

As can be seen in FIG. 3, the cover 212 defines an aperture 216 and the housing 208 defines an aperture 218. A tie rod connector 220 extends through the apertures 216, 218. A clip 221 is provided between the tie rod connector 220 and the rim of the aperture 216 to help prevent the entry of dust through the aperture 216. A pair of fasteners 222 is inserted through the tie rod connector 220 to fasten the tie rod connector 220 to the rack 202. The tie rod connector 220 provides the connection between the rack 202 and left and right ties rods 224. The inner ends of the tie rods 224 are connected to the tie rod connector 220 and the outer ends of the tie rods 224 are connected to the rear of their respective knuckles 68 rearward of the steering axes.

As the left and right tie rods 224 are mirror images of each other, only the right tie rod 224 will be described in detail. Components of the left tie rod 224 that correspond to those of the right tie rod 224 have been labeled with the same reference numerals in the figures.

The left end of the right tie rod 224 consists of a tie rod end 226. The tie rod end 226 is connected to the tie rod connector 220 via a ball joint 228. A flexible cover 230 (not shown for the left tie rod 224) is provided between the tie rod connector 220 and the tie rod end 226 to cover the ball joint 228. The right end of the right tie rod 224 consists of a tie rod end (not shown). This tie rod end is connected between tabs (not shown) at the rear of the right knuckle 68 via a ball joint (not shown).

The rack and pinion assembly 200 will be described in more detail below.

The operation of the steering assembly 100 in order to make a right turn will now be described. The directions provided in this description are as they would be understood from the point of view of a driver sitting in the driver seat 24. It should be understood that the operation of the steering assembly 100 in order to make a left turn would have the components of the steering assembly 100 move in the opposite directions. To make a right turn, the driver turns the steering wheel 28 clockwise. In response, the steering column 104 and the pinion 206 turn clockwise. The rack 202 translates toward the left of the vehicle 10. In response, the left tie rod 224 translates left and pushes the back of the left knuckle 68 toward the left and the right tie rod 224 translates left and pulls the back of the right knuckle 68 toward the left. As a result, the knuckles 68 and the front wheels 14 pivot about their respective steering axes (clockwise as view from above the vehicle 10) to steer the vehicle 10 to make a right turn.

Turning now to FIGS. 3 to 12, the rack and pinion assembly 200 and its various components will be described in more detail.

The housing 208 is made of multiple portions: a main housing portion 232, a housing end 234 and a pinion housing 236. The housing end 234 is fastened to the right end of the main housing portion 232 and the pinion housing 236 is fastened to the left end of the main housing portion 232.

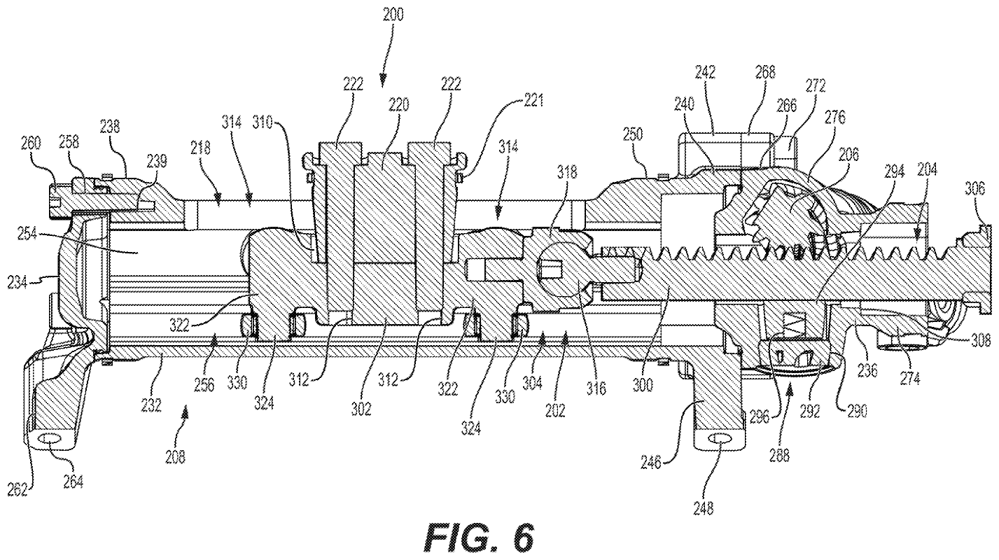

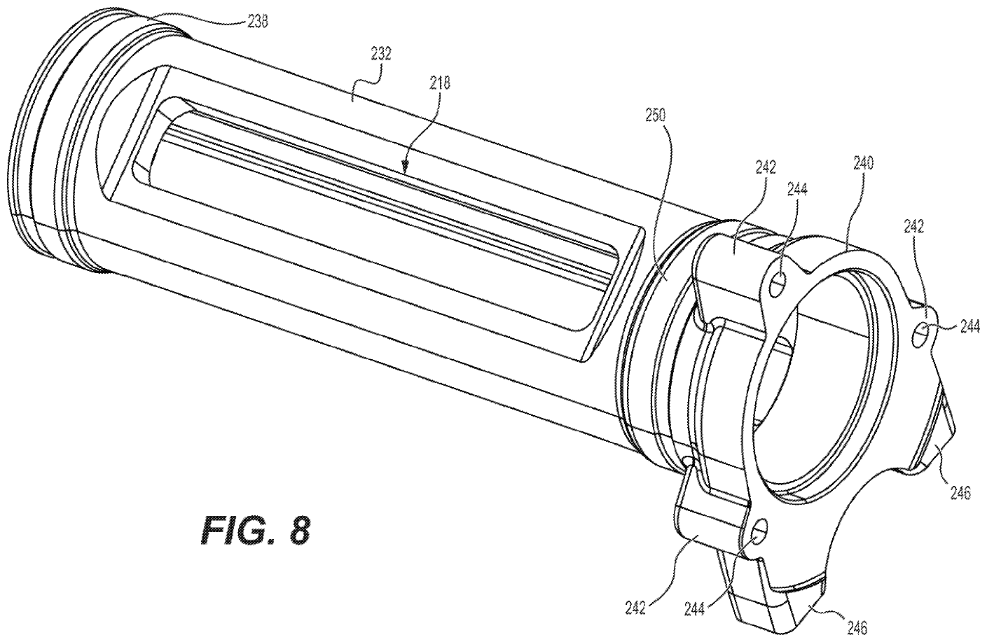

With reference to FIGS. 8 to 10, the main housing portion 232 defines the aperture 218. As can be seen, the aperture 218 is generally rectangular in shape and extends a majority of a width of the main housing portion 232. The main housing portion 232 has a flange 238 at a right end thereof The portion of the right end of the main housing portion 232 radially inward of the flange 238 is open. Three threaded apertures 239 (one of which is shown in FIG. 6) are defined in the right end of the main housing portion 232 to permit the fastening of the housing end 234. It is contemplated that the main housing portion 232 could have more or less than three threaded apertures defined in its right end. The main housing portion 232 has a mounting flange 240 at a left end thereof. The portion of the left end of the main housing portion 232 radially inward of the mounting flange 240 is open as can be seen in FIG. 8. The mounting flange 240 has three protrusions 242. Each protrusion 242 defines a threaded aperture 244 in the end of the mounting flange 240 to permit the fastening of the pinion housing 236. It is contemplated that the mounting flange 240 could have more or less than three protrusions 242 and threaded apertures 244. The mounting flange 240 also has two legs 246. Each leg 246 defines a threaded aperture 248 in an end thereof (one of which is shown in FIG. 6). The apertures 248 are used to fasten the rack and pinion assembly 200 to the frame 12 of the vehicle 10. The main housing portion 232 also has a flange 250 located to the right of the mounting flange 240.

With reference to FIG. 2, the right bellow 214 extends between the cover 212 and the flange 238, and the left bellow 214 extends between the cover 212 and the flange 250. As the cover 212 translates over the main housing portion 232 with the translation of the rack 202, one bellow 214 expands while the other bellow contracts 214. Which one of the bellows 214 expands and which one contracts is determined by the direction of translation of the cover 212 and the rack 202. The bellows 214 help prevent the entry of dust inside the housing 208 via the aperture 218.

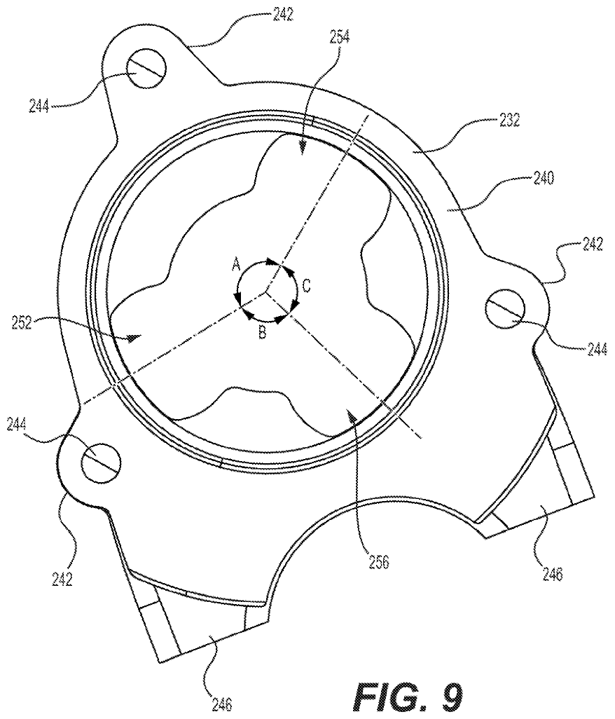

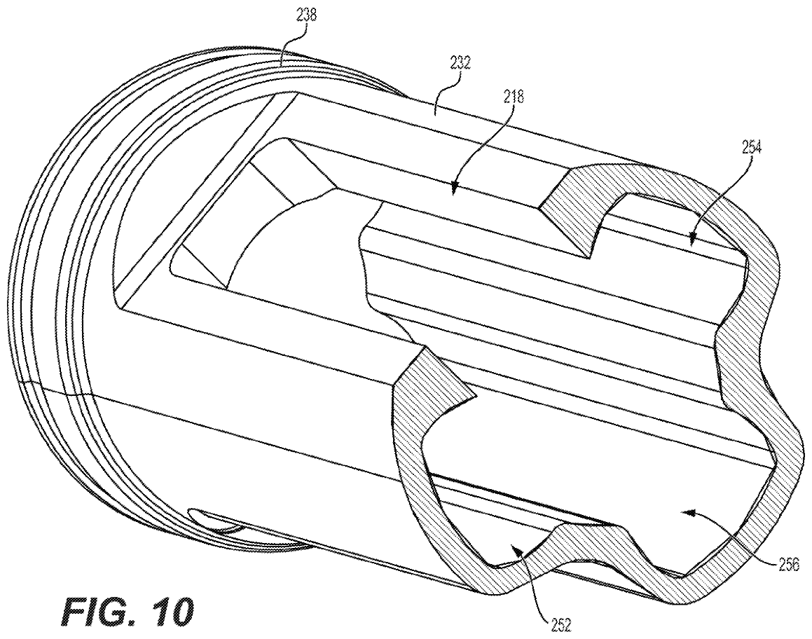

Returning to FIGS. 8 to 10, the main housing portion 232 defines three angularly spaced laterally extending internal grooves 252, 254, 256. As best seen in FIG. 10, the aperture 218 is circumferentially between the grooves 252 and 254, and the groove 256 is disposed opposite the aperture 218. As can be seen in FIG. 9, the angle A between the grooves 252 and 254 is greater than the angle B between the grooves 252 and 256, and the angle A is also greater than the angle C between the grooves 254 and 256. The angle A is greater than the angles B and C to provide the space necessary for the aperture 218. In the present embodiment, the angles B and C are equal to each other, but it is contemplated that they could be different from each other. In the present embodiment, the angle A is 150 degrees and the angles B and C are 105 degrees each, but other angles are contemplated. As can be seen in FIG. 9, the sides of the grooves 252, 254, 256 are concave. The grooves 252, 254, 256 extend almost the entire width of the main housing portion 232. More specifically, as can be seen in FIGS. 6, in the present embodiment the grooves 252, 254, 256 extend from the right side of the flange 238 to the left side of the flange 250. The grooves 252, 254, 256 are sufficiently long to accommodate the full translation of the rack 202 toward the left and the right. It is contemplated that instead of being defined in an inner surface of the main housing portion 232, the grooves 252, 254, 256 could be defined in a liner disposed inside the main housing portion 232. Such a liner would form part of the housing 208. It is contemplated that the main housing portion 232 could define more or less than three grooves 252, 254, 256. It is contemplated that in some embodiments, the grooves 252, 254, 256 could omitted.

With reference to FIGS. 3, 4 and 6, the housing end 234 defines three apertures 258 (one of which is shown in FIG. 6) corresponding to the threaded aperture 239 defined in the right end ofthe main housing portion 232. The housing end 234 is fastened to the main housing portion 232 by three fasteners 260 inserted through the apertures 258 and 239. As a result, the housing end 234 closes the right open end of the main housing body 232. It is contemplated that the number of apertures 258 and fasteners 260 could be different depending on the number of threaded apertures 239. The housing end 234 also has two legs 262. Each leg 262 defines a threaded aperture 264 in an end thereof (one of which is shown in FIG. 6). The apertures 264 are used to fasten the rack and pinion assembly 200 to the frame 12 of the vehicle 10.

With reference to FIGS. 3, 4 and 6, the pinion housing 236 has a mounting flange 266 at a right end thereof The mounting flange 266 has three protrusions 268 corresponding to the protrusions 242 of the mounting flange 240 the main housing portion 232. Each protrusion 268 defines an apertures 270 corresponding to the threaded apertures 244 in the mounting flange 240. The pinion housing 236 is fastened to the main housing portion 232 by three fasteners 272 inserted through the apertures 270 and 244. It is contemplated that the number of protrusions 268, apertures 270 and fasteners 272 could be different depending on the number of protrusions 242 and threaded aperture 244.

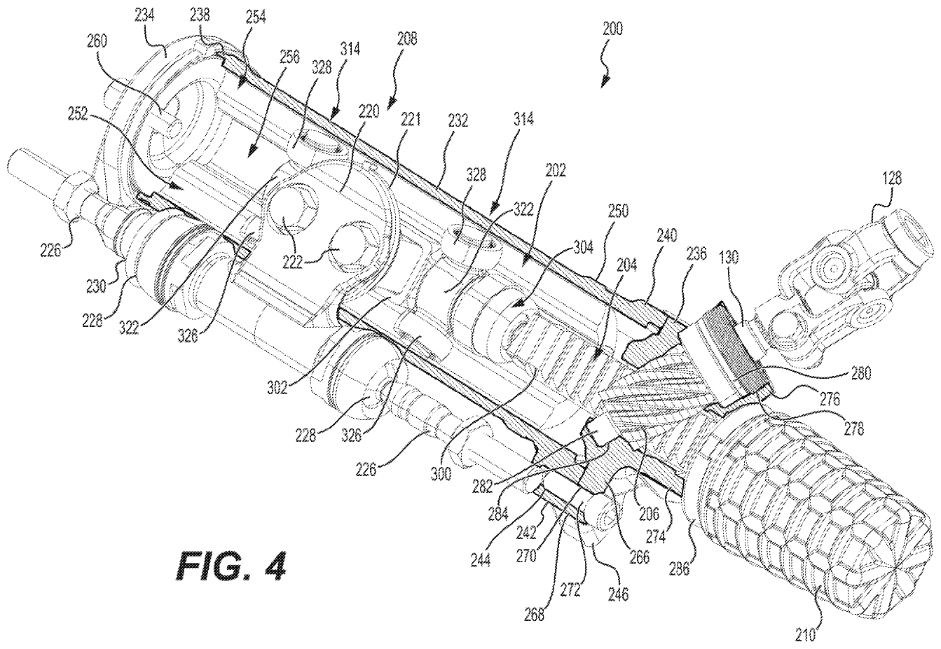

As can be seen in FIGS. 3 and 4, the pinion housing 236 has a generally cylindrical portion 274 that extends laterally and another generally cylindrical portion 276 that extends at an angle to the portion 274. The left end of the generally cylindrical portion 274 is open. The passages defined by the two portions 274 and 276 communicate with each other. Part of the rack 202 is received in the portion 274 as will be described in more detail below. The portion 276 receives part of the pinion 206 and of the input shaft 130 as can be seen in FIG. 4. The portion 276 has an internal thread 278. A bearing housing 280 is threaded into the portion 276. The bearing housing 280 houses bearings (not shown) that rotationally support the pinion 206 and input shaft 130 in the pinion housing 236. As seen in FIG. 4, the end of the pinion 206 defines a shaft 282 rotationally supported in a bore 284 defined in the pinion housing 236.

With reference to FIGS. 3 and 4, the right end of the cap 210 is placed over the left end of the portion 274 of the pinion housing 236. The left end of the cap 210 is closed. A collar 286 is place around the right end of the cap 210 to retain the cap 210 onto the pinion housing 236.

As can be seen in FIG. 6, a slider assembly 288 is provided in the pinion housing 236 opposite the pinion 236. The pinion housing 236 defines an aperture 290 in a bottom thereof. The slider assembly 288 is inserted into the aperture 290. The slider assembly 288 includes a threaded cap 292, a slider 294 and a spring 296 connected between the cap 292 and the slider 294. The cap 292 is threaded into the aperture 290. The slider 294 abuts a bottom of the rack 202, such that the rack 202 is disposed between the pinion 206 and the slider 294. The spring 296 biases the slider 294 against the bottom of the rack 202. The slider 294 wears over time as the rack 202 translates left and right. By biasing the slider 294 against the rack 202, the slider 294 remains in contact with the rack even as the slider 294 wears. Also, the slider 294 also helps the rack 202 to maintain a proper orientation relative to the pinion 206.

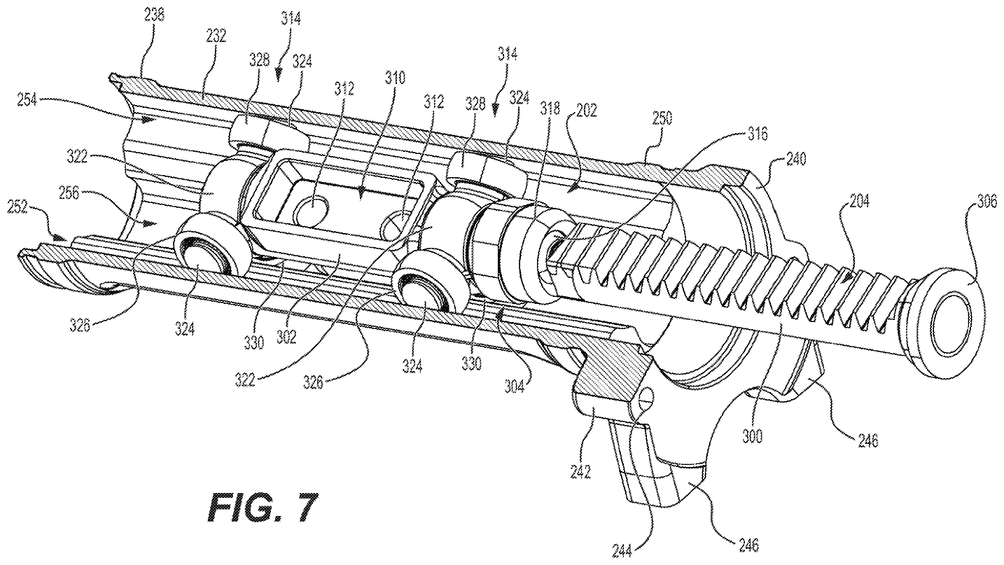

Turning now to FIGS. 6 and 7, the rack 202 will be described in more detail. The rack 202 includes a left rack portion 300, a right rack portion 302 and an articulated joint 304 connecting the left and right rack portions 300, 302 together.

The left rack portion 300 has the teeth 204 on an upper side thereof. As can be seen in FIG. 6, the left rack portion 300 is the portion of the rack 202 that is abutted by the slider 294 and is disposed between the pinion 206 and the slider 294.

The left rack portion 300 extends inside the main housing portion 232, the pinion housing 236 and the cap 210. A flanged cap 306 is connected to the left end of the left rack portion 300. As the rack 202 translates to the right, the cap 306 eventually abuts a shoulder 308 (FIG. 6) defined in the pinion housing 236 to prevent further translation of the rack 202 toward the right.

The right rack portion 302 extends inside the main housing portion 232. The right rack portion 302 defines a rectangular recess 310. Two threaded apertures 312 are defined in a bottom of the recess 310. As seen in FIG. 6, the tie rod connector 220 is received in the recess 310. The fasteners 222 are inserted through the tie rod connector 220 and are threaded into the apertures 312. Two spider assemblies 314 are connected to the left and right ends of the right rack portion 302. The spider assemblies 314 translate with the right rack portion 302 as the rack 202 translates. The tie rod connector 220 is disposed laterally between the two spider assemblies 314. The spider assemblies 314 will be described in more detail below. It is contemplated that only on spider assembly 314 could be provided.

The articulated joint 304 helps prevent torsion of the right rack portion 302, which could occur under high steering loads, from being transmitted to the left rack portion 300. As a result, the alignment between the pinion 206 and the left rack portion 300 is not affected by torsion of the right rack portion 302. It is contemplated that in some embodiments, the articulated joint 304 could be omitted such that the left and right rack portions 300, 302 are fixedly connected to each other or such that the rack 202 is a single part.

In the present embodiment, the articulated joint 304 is a ball joint 304. It is contemplated that other types of articulated joints could be used. The ball joint 304 includes a ball 316 received in a socket 318. As best seen in FIG. 6, the ball 316 is threaded into the right end of the left rack portion 300 and the socket 318 is threaded into the left end of the right rack portion 302. The ball joint 304 permits relative torsion between the left and right rack portions 300, 302 and also permits the left and right rack portions 300, 302 to pivot relative to each other. This relative motion between the left and right rack portions 300, 302 generally occurs only during high steering load conditions. As the rack 202 translates to the left, the socket 318 eventually abuts the right end 320 (FIG. 6) of the pinion housing 236 to prevent further translation of the rack 202 toward the left.

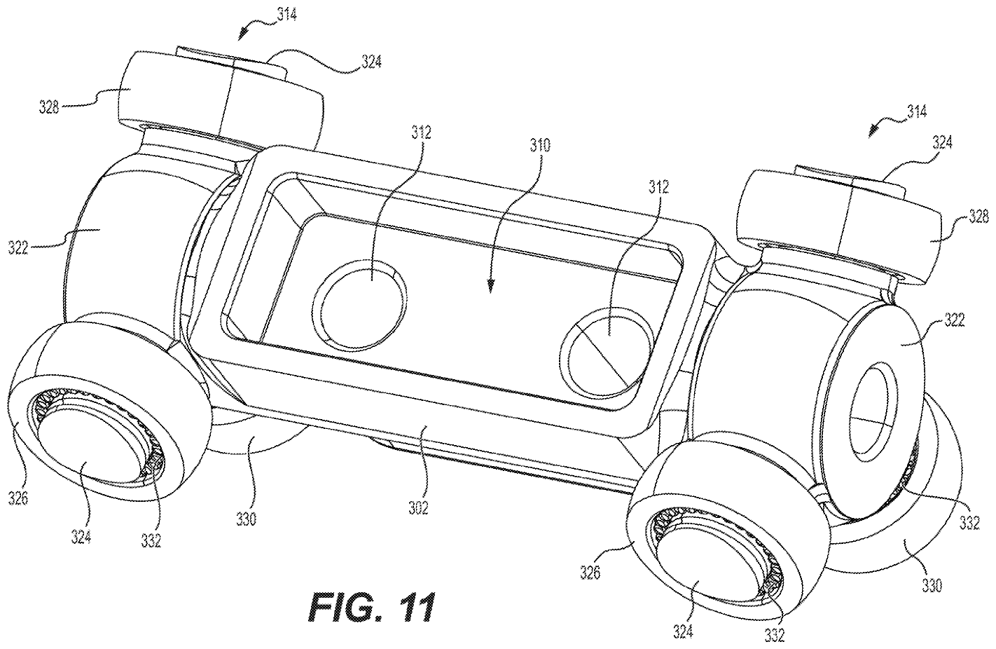

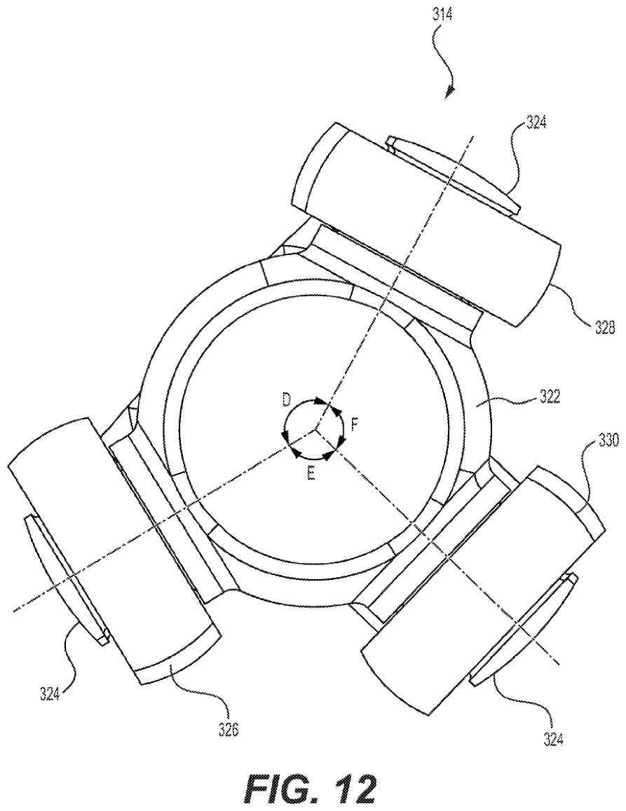

Turning now to FIGS. 11 and 12, the spider assemblies 314 will be described in more detail. As the left and right spider assemblies 314 are mirror images of each other, only the right spider assembly 314 will be described in detail. Components of the left spider assembly 314 that correspond to those of the right spider assembly 314 have been labeled with the same reference numerals in the figures.

The spider assembly 314 includes a spider 322 having three angularly spaced legs 324 and three angularly spaced rolling elements 326, 328, 330 rotationally connected to the legs 324. The right spider 322 is connected to the right end of the right rack portion 302. More specifically, the right spider 322 is integrally formed with the right end of the right rack portion 302, but it is contemplated that the spider 322 could be connected to the right rack portion 302 in other ways. The rolling elements 326, 328, 330 roll along the inner surface of the housing 208 as the rack 202 translates. More specifically, the rolling elements 326, 328, 330 are received in the grooves 252, 254, 256 respectively, as seen in FIG. 7, and roll inside their corresponding grooves 252, 254, 256. By rolling inside the grooves 252, 254, 256, the rolling elements 326, 328, 330 help maintain proper orientation of the right rack portion 302. It is contemplated that the number of legs 324 and rolling elements 326, 328, 330 could be different depending on the number of grooves 252, 254, 256. In embodiments where no grooves 252, 254, 256 are provided, it is contemplated that the rolling elements 326, 328, 330 could roll along alternative features of the inner surface of the housing 208. For example, the rolling elements 326, 328, 330 could roll along rails provided in the housing 208.

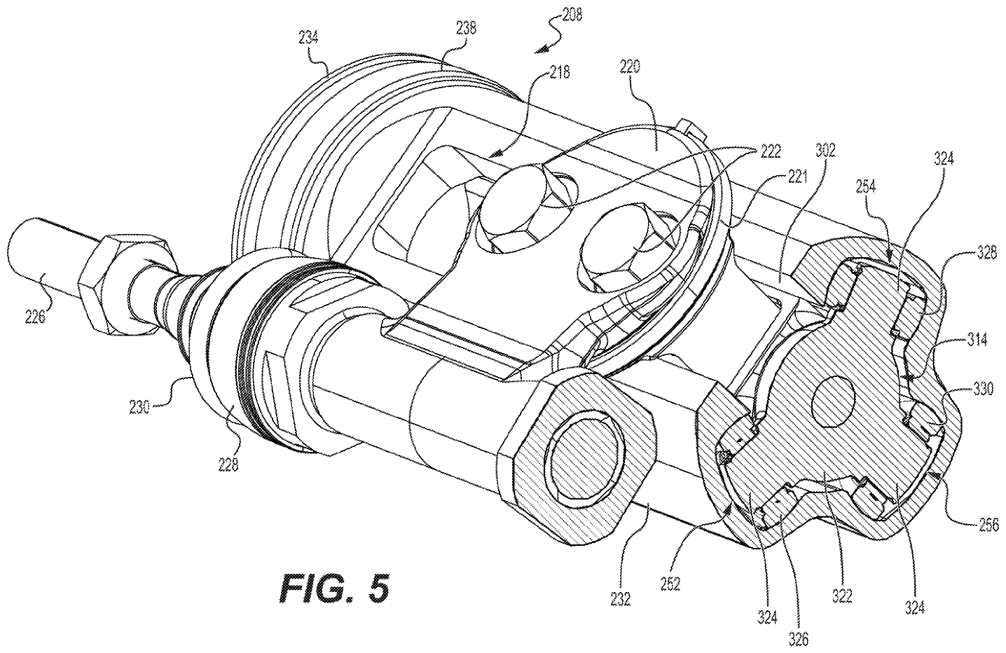

In the present embodiment, the rolling elements 326, 328, 330 are rollers 326, 328, 330. The rollers 326, 328, 330 each have a convex outer surface corresponding to the concave sides of its corresponding groove 252, 254, 256 (as can be seen in FIG. 5 for the left spider assembly 314). Each roller 326, 328, 330 is rotationally connected to its corresponding leg 324 of the spider 322 by a pin bearing 332 (FIG. 11).

The angular positions of the rollers 326, 328, 330 correspond to the angular positions of their corresponding grooves 252, 254, 256. As can be seen in FIG. 5 for the left spider assembly 314, the aperture 218 is circumferentially between the rollers 326 and 328, and the roller 330 is disposed opposite the aperture 218. As can be seen in FIG. 12, the angle D between the rollers 326 and 328 is greater than the angle E between the rollers 326 and 330, and the angle D is also greater than the angle F between the rollers 328 and 330. The angle D is greater than the angles E and F to provide the space necessary for the aperture 218. In the present embodiment, the angles E and F are equal to each other, but it is contemplated that they could be different from each other. In the present embodiment, the angle D is 150 degrees and the angles E and F are 105 degrees each, but other angles are contemplated.

It is contemplated that the spider assemblies 314 could be replaced by other components having rolling elements other than rollers. For example, the spider assemblies 314 could be replaced by ball bearing assemblies. In such an embodiment, the ball bearing assemblies are mounted to the right rack portion 302 and translate with the right rack portion 302. Each ball bearing assembly has a ball bearing holder in which the rolling elements, namely ball bearings, are received to be held in position relative to the right rack portion 302. The ball bearings roll inside grooves defined in the housing.

Modifications and improvements to the above-described embodiments ofthe present technology may become apparent to those skilled in the art. The foregoing description is intended to be exemplary rather than limiting. The scope of the present technology is therefore intended to be limited solely by the scope of the appended claims.

1. A rack and pinion assembly for a steering assembly, the rack and pinion assembly comprising:
a housing;
a rack disposed in the housing, the rack being translatable in the housing;
a pinion engaging the rack for causing translation of the rack; and
at least one rolling element connected to the rack, the at least one rolling element being translatable with the rack, the at least one rolling element rolling along an inner surface of the housing as the rack translates.

2. The rack and pinion assembly of claim 1, wherein:
the housing defines at least one laterally extending groove; and
the at least one rolling element rolls inside the at least one laterally extending groove.

3. The rack and pinion assembly of claim 2, wherein the at least one rolling element is at least one first rolling element; and
further comprising at least one second rolling element connected to the rack, the at least one second rolling element being laterally spaced from the at least one first rolling element, the at least one second rolling element being translatable with the rack, the at least one second rolling element rolling inside the at least one groove.

4. The rack and pinion assembly of claim 2, wherein:
the at least one laterally extending groove is three angularly spaced laterally extending grooves;
the at least one rolling element is three angularly spaced rolling elements; and
each of the three rolling elements is received in a corresponding one of the three laterally extending grooves.

5. The rack and pinion assembly of claim 4, wherein:
the housing defines an aperture;
the three laterally extending grooves include first, second and third grooves;
the aperture is circumferentially between the first and second grooves;
the third groove is opposite the aperture;
a first angle between the first and second grooves is greater than a second angle between the second and third grooves;
the first angle is greater than a third angle between the first and third grooves; and
the rack and pinion assembly further comprises:
a tie rod connector fastened to the rack; and
at least one fastener fastening the tie rod connector to the rack, the fastener passing through the aperture,
the tie rod connector being configured to connect to tie rods.

6. (canceled)

7. The rack and pinion assembly of claim 4, further comprising a spider connected to the rack; and
wherein:
the spider has three legs; and
each of the three rolling elements is rotationally connected to a corresponding one of the three legs.

8. The rack and pinion assembly of claim 1, wherein the at least one rolling element is three angularly spaced rolling elements.

9. The rack and pinion assembly of claim 8, wherein:
the housing defines an aperture;
the three rolling elements include first, second and third rolling elements;
the aperture is circumferentially between the first and second rolling elements;
the third rolling element is opposite the aperture;
a first angle between the first and second rolling elements is greater than a second angle between the second and third rolling elements;
the first angle is greater than a third angle between the first and third rolling elements; and
the rack and pinion assembly further comprises:
a tie rod connector fastened to the rack; and
at least one fastener fastening the tie rod connector to the rack, the fastener passing through the aperture,
the tie rod connector being configured to connect to tie rods.

10. (canceled)

11. The rack and pinion assembly of claim 8, further comprising a spider connected to the rack; and
wherein:
the spider has three legs; and
each of the three rolling elements is rotationally connected to a corresponding one of the three legs.

12. The rack and pinion assembly of claim 8, wherein the three rolling elements are three first rolling elements; and
further comprising three second rolling elements connected to the rack, the three second rolling element being laterally spaced from three first rolling elements, the three second rolling element being translatable with the rack, the three second rolling elements rolling along the inner surface of the housing as the rack translates.

13. The rack and pinion assembly of claim 12 wherein:
the three second rolling elements are rotationally connected to a spider;
the spider is connected to the rack;
the spider has three legs; and
each of the three second rolling elements is rotationally connected to a corresponding one of the three legs.

14. The rack and pinion assembly of claim 1, wherein the at least one rolling element is at least one first rolling element; and
further comprising at least one second rolling element connected to the rack, the at least one second rolling element being laterally spaced from the at least one first rolling element, the at least one second rolling element being translatable with the rack, the at least one second rolling element rolling along the inner surface of the housing as the rack translates.

15. (canceled)

16. The rack and pinion assembly of claim 1, wherein the at least one rolling element is at least one roller.

17. (canceled)

18. (canceled)

19. (canceled)

20. The rack and pinion assembly of claim 1, wherein:
the rack includes:
a first rack portion having teeth for engaging the pinion; and
a second rack portion connected to the first rack portion by an articulated joint;
the at least one rolling element is at least one first rolling element connected to the second rack portion;
the rack and pinion assembly further comprises:
at least one second rolling element connected to the second rack portion, the at least one second rolling element being laterally spaced from the at least one first rolling element, the at least one second rolling element being translatable with the rack, the at least one second rolling element rolling along the inner surface of the housing as the rack translates;
the housing defines an aperture; and
the rack and pinion assembly further comprises:
a tie rod connector fastened to the second rack portion, the tie rod connector being disposed laterally between the at least one first rolling element and the at least one second rolling element; and
at least one fastener fastening the tie rod connector to the second rack portion, the fastener passing through the aperture,
the tie rod connector being configured to connect to tie rods.

21. The rack and pinion assembly of claim 20, further comprising:
a first spider connected to the second rack portion, the first spider having three legs; and
a second spider connected to the second rack portion, the second spider having three legs; and
wherein:
the tie rod connector is disposed laterally between the first and second spiders;
the at least one first rolling element is three first rolling elements;
each of the three first rolling element is rotationally connected to a corresponding one of the three legs of the first spider;
the at least one second rolling element is three second rolling elements; and
each of the three second rolling element is rotationally connected to a corresponding one of the three legs of the second spider.

22. The rack and pinion assembly of claim 21, wherein:
the housing defines three angularly spaced laterally extending grooves;
each of the three first rolling elements is received in a corresponding one of the three laterally extending grooves; and
each of the three second rolling elements is received in a corresponding one of the three laterally extending grooves.

23. The rack and pinion assembly of claim 20, wherein:
the at least one first rolling element is at least one first roller; and
the at least one second rolling element is at least one second roller.

24. A steering assembly comprising:
a steering wheel;
a steering column operatively connected to the steering wheel;
the rack and pinion assembly of claim 1, the pinion being operatively connected to the steering column;
a left tie rod operatively connected to the rack; and
a right tie rod operatively connected to the rack.

25. The steering assembly of claim 24, further comprising a power steering unit operatively connected to the steering column.

26. A vehicle comprising:
a frame;
at least one seat connected to the frame;
a front left wheel operatively connected to the frame;
a front right wheel operatively connected to the frame;
at least one rear wheel; and
the steering assembly of claim 24, the left tie rod being operatively connected to the front left wheel, and the right tie rod being operatively connected to the front right wheel.
